(19) United States
(12) Patent Application Publication
(10) Pub. No.: US 2011/0083266 A1
(43) Pub. Date: Apr. 14, 2011

(54) PHYSICAL THERAPY DEVICE TO ASSIST INDIVIDUAL TO STAND ERECT

(75) Inventor: Patrick G. Herron, Sandusky, OH (US)

(73) Assignee: Herron Designs, Ltd., a Ohio Company, Huron, OH (US)

(21) Appl. No.: 12/898,512

(22) Filed: Oct. 5, 2010

Related U.S. Application Data
(60) Provisional application No. 61/250,044, filed on Oct. 9, 2009.

(51) Int. Cl. A61G 7/10

(52) U.S. Cl. 5/83.1

(57) ABSTRACT

A lifting device for assisting individuals from a seated position to an upstanding position utilizes a disadvantage of a long lever arm design, i.e., the small range of lever motion, to its advantage. The device includes a frame and a seat connected to the frame for supporting an individual. The seat is connected to the frame by at least one lever movable between a first lower position for loading the individual into the lifting device and a second higher position, into which the lifting device is moved by applying force to a first point on the lever resulting in the individual being placed in the upstanding position. A superior lifting force is achieved by applying force to the lever assembly by way of a force transfer element connected to the lever assembly by a flexible coupling. The device also accommodates right-versus left-side of the body manipulation as well.

### CROSS REFERENCE TO RELATED APPLICATIONS

This application claims the benefit of U.S. Provisional Application No. 61/250,044, filed Oct. 9, 2009, the disclosure of which is hereby incorporated by reference.

### FIELD OF THE INVENTION

The present invention relates to the field of physical therapy, and more particularly, to a physical therapy machine to assist an individual to stand erect.

### BACKGROUND

Many patients who cannot lift themselves to a standing position are physically frail due to age, or conditions, such as wasting, which accompany cancer, HIV, or other illnesses. Such patients are often physically fragile, but they are generally lifted easily due to their light weight. However, some patients, such as bariatric patients, are of a size and weight that ambulation is dangerous or not medically advisable. Furthermore, such patients are often in poor physical condition, which raises the risk associated with lifting. A fall for such a patient can be devastating. However, their weight makes transportation difficult and increases the risk of failure of most lift designs.

Furthermore, many lift designs in common use do not take into account the fact that a patient may have to spend significant amounts of time in a lift to minimize the number of times a patient must be discharged from the lift, only to be relifted to attend a different activity. In such cases, the ability of a patient to self-entertain is important to the endurance of long periods in the lifts. However, present designs are often cluttered with obstructions to the side and front of the lift passenger, impeding the lateral and forward motion of the patient.

Furthermore, the following shortcomings with the prior art were observed by caretakers and bariatricians alike. In many cases, lift designs did not permit safe lifting of obese individuals; no planar surface was included upon which the patient could write or perform entertainment activities such as reading a book or working a puzzle while in the lift; equipment features did not accommodate paralyzed patients with independent adjustability of left and right side lift features; the lift design employed numerous moving parts, often electrically—driven, which would wear out after relatively short periods of time, with such components adding substantially to the cost of the lift; the operation of the lift was often not intuitive, and machine training or manuals were necessary before therapists could use it.

Many individuals undergo occupational and/or physical therapies in response to bodily injury or atrophy. Physical activity and treatments geared toward rehabilitation are especially burdensome and difficult for the aged or obese. Caretakers are often physically unable to lift or move a large-statured or obese individual. More than ever before, the increase in the number of obese patients has presented a need for an improved heavy-duty device to assist an individual in standing and moving. Bed sores and other conditions resulting from immobilizing conditions such as strokes, for example, may also be alleviated or altogether reversed.

It would be advantageous to provide a new device for transitioning bariatric and other patients from a seated position to a standing position. A lift having an easily accessible seat and a minimum of side obstructions is required in practice. It would be desirable that such a device be capable of lifting large-statured and obese individuals as well as more modestly-sized persons. Such a device should also accommodate patients having suffered physical trauma or special conditions such as stroke that aggravate their stance, make them favor one side or make standing especially difficult.

### SUMMARY OF THE INVENTION

One embodiment of the device includes a frame, a lever assembly having a pair of arms connected to the frame, and a seat for supporting an individual. The seat may be releasably connected at each of its sides, respectively, to one of the pair of arms. The lever assembly may be movable between a first lower position for loading the individual into the lifting device and a second higher position, into which the lifting device is moved by applying force to the lever assembly. As a result, the individual is positioned in the upstanding position.

In one aspect, the device may include a pair of stop members for stopping the front portions of legs of the individual when the lifting device moves between the lower position and the higher position. The stop members may be connected to the frame. The stop members may be movable to and fro independently of each other. The stop members may be movable transverse to the longitudinal axis of the individual's legs, so as to be optimally positioned irrespective of the stature of the individual so that the individual's legs appropriately pivot at the knee and straighten the legs when a force is applied to the lever assembly.

In another aspect, the device may include a sliding member connected to the lever assembly. The movement of the lever assembly may be in response to a force applied to the sliding member.

In still another aspect, at least one pulley may be operably connected to the frame between the sliding member and the lever assembly. An adjustable link member may connect the sliding member and the frame for moving the sliding member up and down relative to the frame. The adjustable link may be a hydraulic cylinder.

In yet another aspect, the frame may include a chest plate connected to the frame for supporting the torso of the individual.

Additionally, a way of increasing the accessibility of a lift for large patients is to have a lift design with a seat that is spatially removed from the mechanics of the lift. In order to meet this requirement and avoid obstructions to the side of the patient, the seat may be on a long lever arm. Such a long lever arm design presents problems in that it is mechanically disadvantaged, inevitably generating large forces on the lift components. Furthermore, because the lever arm is long, the design also constrains the scope of lever motion such that the lever only travels through a small range of positions, most of which are mechanically disadvantaged, during the process of lifting a patient from a sitting position to a standing position. As a result, no part of the range of lever motion is free from the large forces generated by supporting a heavy patient during lifting. Thus, an embodiment of the invention includes a lifting device with a frame defined by two K frames.

Each of the K frames includes: (i) an upright element; (ii) a foundation element to which the upright element is secured at an upright element securing point such that the upright and foundation elements form an angle. The angle may be in the range of from 70 to 110 degrees; (iii) a brace element attached to both the upright and foundation elements at upright connection and foundation connection points, respectively. The angle between the brace and the upright elements may be in the range of from about 40 to about 50 degrees; (iv) a lever element secured to the brace at a lever connection point such that the lever extends away from the lever connection point for a distance in the range of from 4.5 to 40 inches; (v) a pulley positioned on the upright element at a pulley position. The pulley position is within three inches from the upright connection point; and (vi) a flexible coupling.

In another aspect of the invention, a seating member may be attached to each lever element at a seat connection point that is a distance in the range of from 4 to 38 inches from the lever connection point.

In another aspect, two flexible linking members may be provided.

In yet another aspect, an upper cross-connector may extend horizontally between the upright elements at or above the height of the upright connection point. A lower cross connector connecting the foundation elements also may be provided.

In still another aspect, a downwardly extensible press element may be attached to the upper cross connector. The press element may be capable of extending downward from the upper cross connector.

In another aspect, a force transfer element may be attached to the downwardly extensible press element at one or more force transfer element attachment points, such that upon extension of the press element, the force transfer element is moved downward. The force transfer element may extend transversely to either side of the press element. The flexible couplings may attach to opposite ends of the force transfer element and extend upwardly from the force transfer element, over the closest pulley, and laterally toward a corresponding lever element, attaching thereto such that the angle between the upwardly extending portion and the laterally extending portion is in the range of from about 60 to 120 degrees; and wherein upon full extension of the press element, the angle is in the range of from about 60 to 120 degrees.

### BRIEF DESCRIPTION OF THE DRAWINGS

FIG. 1 is an elevated front side perspective view of an embodiment of the physical therapy machine of the invention.

FIG. 2 is an elevated perspective view of the back side of the physical therapy machine of FIG. 1.

FIG. 3 is an elevated perspective view of the machine of FIG. 1 shown disassembled.

FIG. 4 is a side plan view of an embodiment of the physical therapy machine of the invention shown in the lower position with an individual seated before lifting.

FIG. 5 is another side plan view showing the machine in the higher position after lifting the individual from a sitting to a standing position.

### DETAILED DESCRIPTION OF INVENTION

The inventive design utilizes a disadvantage of the long lever arm design, i.e., the small range of lever motion, to its advantage. The design features a lift initiated by downward motion which is converted to roughly horizontal motion via a flexible coupling operating over a pulley located at or near the intersection of the brace element and the upright element. The resultant force on the pulley due to (1) the downward motion of the extensible member and (2) the roughly horizontal pull due to the weight of the patient is directed roughly along the longitudinal axis of the brace. The shallow range of lever element angles minimizes the deviation of the resultant force from the above-mentioned axial direction during the operation of the lift.

In other words, the low range of lever angles proportionally prohibits distribution of the lifting force in directions other than along the brace element's axis. Furthermore, the fact that the lever arm is attached to the brace element results in a counterforce in the direction of the brace. Thus, a substantial amount of the force generated by supporting a patient is cancelled out along the brace element, which has a high mechanical strength and resistance to deformation or failure when stresses are applied along the long axis.

Generally, the device 10 includes a frame 20 comprised of a foundation element that includes a pair of oppositely disposed legs 22. The legs are connected by a lower cross connector 32 so as to provide a low center of gravity and overall support to the device during operation. In one embodiment, castors or wheels 33 may be secured for rotation beneath the legs so that the device can move accordingly. Attached to each of the legs is an upright element 21 that extends generally transverse to the longitudinal axis of each respective leg. A brace element 24 extends generally obliquely between each of the legs 22 and its corresponding upright element 23 for added strength and support.

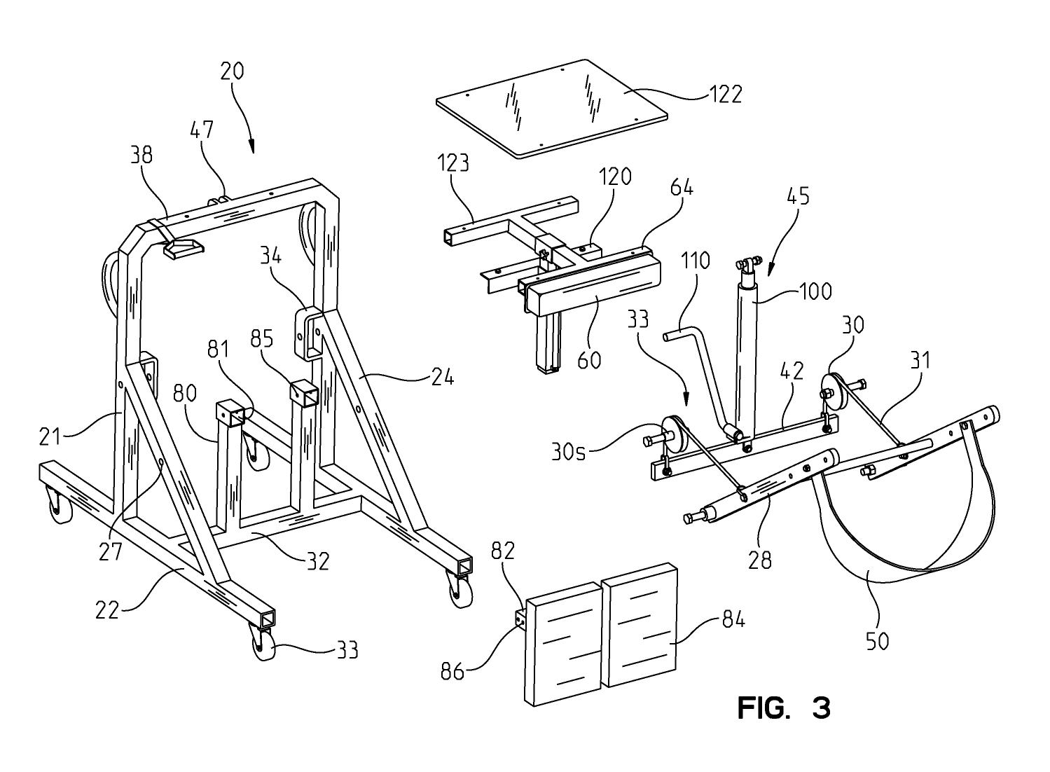

This arrangement of the opposite legs 22, upright element 21, and brace element 24 define what is generally referred to herein as a “K frame.” Referring to FIG. 3, one embodiment of the device 10 includes two K frames, each comprising a foundation element with a leg 22, an upright element 21, a bracing element 24, a lever element 28 and a pulley 30. A downwardly extensible press element (or simply “press element”) 45, a force transfer element 42, two flexible coupling elements 33, and a seat 50 for supporting an individual are operably connected with the supporting K frames. The foundation, upright, brace, and lever elements, the upper 38 and lower 32 cross connectors, as well as other elements, which are required to be rigid and able to undergo mechanical stresses without mechanical compromise, can be formed from a wide range of materials, including steel, other metals or metal alloys, synthetic materials, or other materials having the structural integrity that allows the safe operation of the lift. If desired, metal tubing or other high-strength material conformation can be used.

Each K frame is constructed in accordance with generally known attachment methods that are commensurate with the materials identified above and may comprise welds or other means of joining as long as the mechanical strength requirements of the apparatus herein described are met. The upright element 21 is attached to the foundation 22 at an angle A that is within a range of around ninety degrees. In one embodiment, the angle is in the range of from about 60 to about 120 degrees. In another embodiment, the angle is in the range of from about 80 to 100 degrees. The brace element 24 is positioned such that it makes an angle A′ of approximately forty-five (45) degrees (or at an angle that is within a small range around 45 degrees) with the foundation 22 and the upright 21. In one embodiment the angle is in the range of from 35 to 50 degrees. In another embodiment, the angle is in the range of from about 40 to 50 degrees.

In some embodiments, the K frames are in mutually parallel planes, i.e., the planes that contain the foundation 22, upright 21, brace 24 and lever 28 elements are parallel. In other embodiments, the planes may somewhat diverge or converge to a degree. In some embodiments, the deviation can be such that the planes differ by 2, 5, 10, 20 or 30 degrees.

In one embodiment, the upright elements 21 are joined by a horizontal cross bar 38 that extends across the top of the device and is joined to the upright elements 21 at its opposite ends so as to define an angled top. A clevis comprising a pair of tabs 47 having a bore 49 extending through each of the tabs is welded or otherwise securely connected to the cross bar 38. A bottom cross bar 32 also connects and extends between the two legs 22. A pair of pulley brackets 34 are welded or otherwise securely fastened to the interior surface of each of the upright elements. A pair of upstanding shin stops 80 are connected to the bottom cross bar.

Each shin stop extends upwardly from the bottom cross bar at one end and has an opening 81 at its other end. The openings define an enclosure for receiving a post 82 that is connected to a planer shin plate 84, as shown in FIG. 3. The post is telescopingly received in the opening of each of the shin supports. The opening has a bore 85 extending through it and the shin plate posts have a plurality of bores 86 such that the bores in the post can be selectively aligned with the bore in the opening so that the shin plates 84 can be adjusted accordingly. The shin plates are, therefore, movable to and fro two to eight inches in a direction generally transverse to the longitudinal axis of the frame. Additionally, this mounting structure and configuration makes the shin plates movable independently of each other. This feature is desirable, for example, in cases where stroke has left the patient with paralysis to his right or left legs, and therapy may be directed to the left or right side of the patient accordingly. The surface of the shin plate may include padding for comfort against the shin.

As described in detail below, each of the upright elements 21 has an outward lever element, or arm 28 connected to it at a pivot 27, which includes a spacer 27s. Each of the levers 28 has a pivot end 28′ and a terminal seat end 28″. A seat 50 for supporting an individual is releasably connected at the seat ends. In this manner the seat may be detached from one of the arms and moved beneath the seat (or thighs) of the individual and then reattached to the arm accordingly. In one embodiment, the seat is a belt-like sling device releasably connected by way of a shackle, bolt, or other known means as previously mentioned, as shown in FIG. 3.

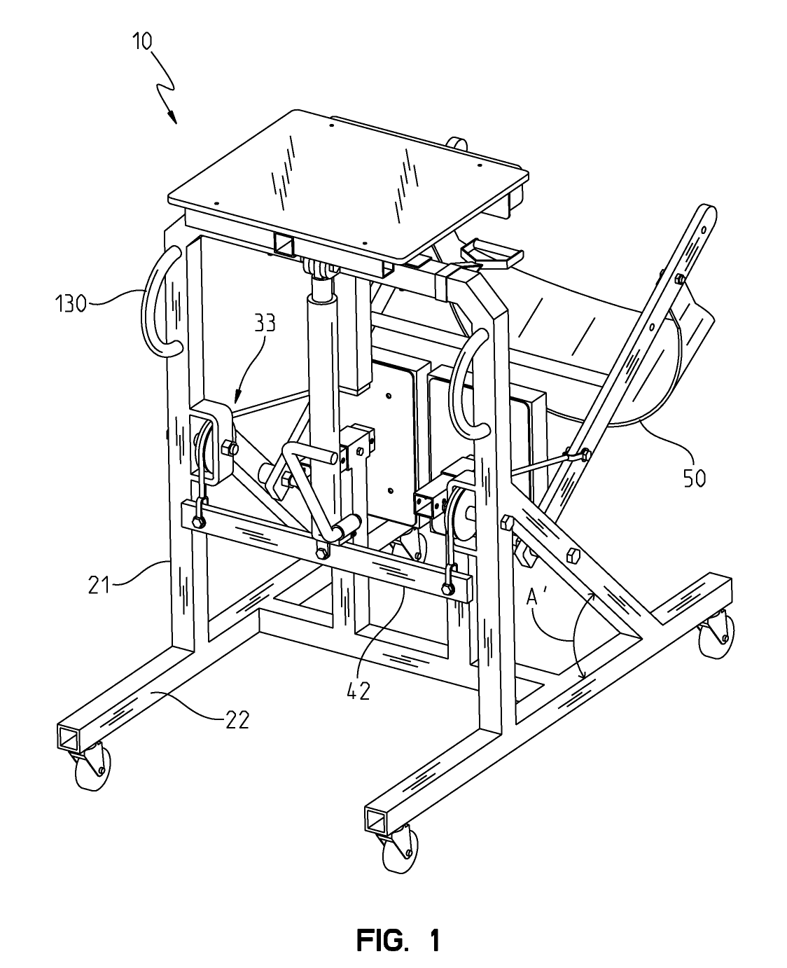

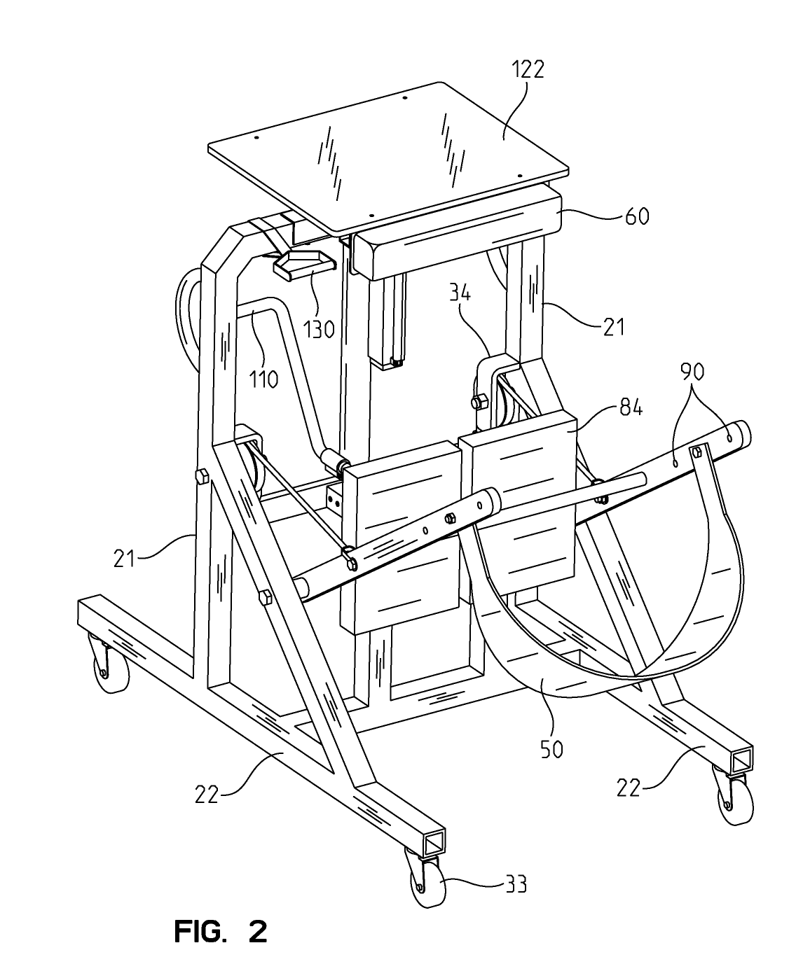

Referring to FIGS. 1-5, a pulley 30 is operably connected for rotation to the interior surface of each of the upright elements 21. The pulley is located on the upright at a height that is lower than, but within about three inches of, the brace/upright intersection. As with other structural elements of the present invention, the pulley 30 can be fabricated from a wide range of materials, but standard materials, such as metals, metal alloys and appropriate synthetic materials, such as aircraft cable, wire rope, UHMW composite(s) and/or nylon webbing are preferred. In any case, the pulley should be able to bear the mechanical stress imposed upon it during operation without crumbling, snapping, breaking or other type of mechanically compromising transformation. Each pulley includes a pulley spacer 30s for spacing the pulley from the interior surface of its respective upright 21 so that it may freely rotate. Each pulley is also at least partially covered by a protective housing, or pulley bracket 34, to avoid injury or interference during operation.

The lever element, or arm 28 extends away from the K frame. The lever element is rotatably attached to the brace element 24, preferably at a lever attachment point 27 approximately midway along the length of the brace, or on the upper half of the brace. Such a position helps to direct much of the force generated by a seated patient along the long axis of the brace element. The lever element, or arm 28 is dimensioned such that it can withstand the high forces occasioned by holding the weight of an obese patient on a long lever arm. It is preferably in the range of from 0.5 to 1.0 inches wide.

Referring to FIG. 3, the K frames are connected by an upper cross connector 38 that extends between the top portions of the upright elements. The press element 45 is attached to and extends downwardly from the middle of the upper cross connector. The mobile portion of the press element is rigidly attached to a force transfer element 42, which extends transversely between the upright elements 21, as shown in FIG. 1. The flexible coupling elements 31 are each attached to opposite ends of the force transfer element 42, extending upward, over the pulley 30, and laterally thereafter. Coupling element 31 attaches to the lever element, or arm 28 at a first point 28p, such that the angle between the upwardly extending portion and the laterally extending portion is in the range of from about 70 to 110 degrees.

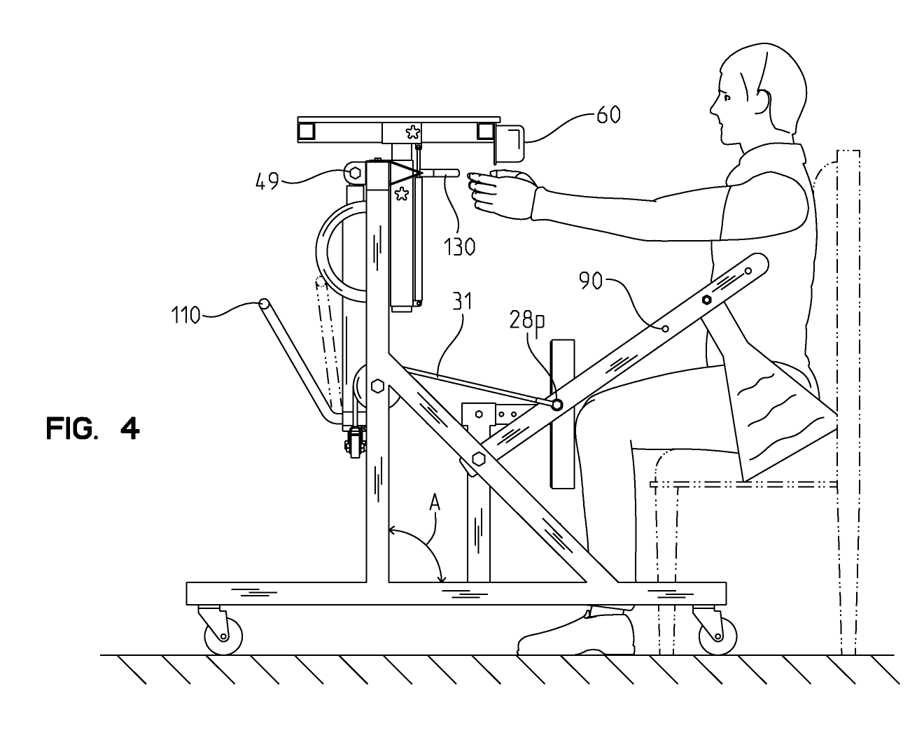

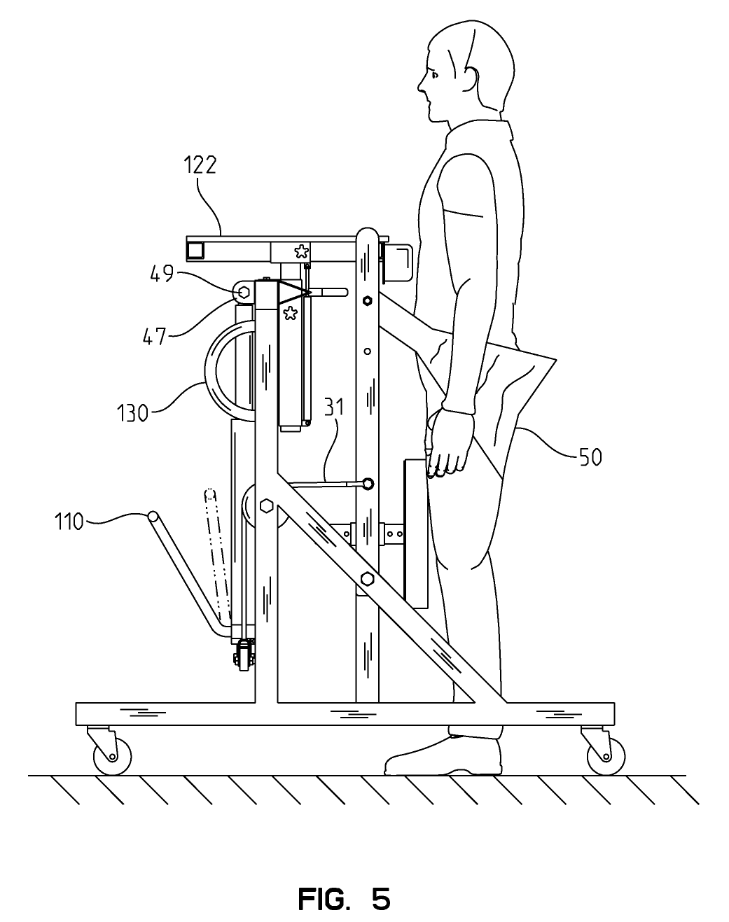

The seat is preferably releasably connected to each of the lever elements. As described above, the seat may be detached from one of the arms and moved beneath the seat of the individual and then reattached to the arm 28 accordingly. In one embodiment, the seat is a belt-like sling device releasably connected by way of a shackle, bolt, or other known means as previously mentioned. The lever elements transition between a first lower position (see FIG. 4) for loading the individual into the lifting device and a second higher position, as shown in FIG. 5. The transition is effected by the downward extension of the press element 45 resulting in a “pulling” force being applied to first point 28p. As a result, the individual is placed in the upstanding position.

If desired, the lever elements may comprise multiple attachment points 90 along their lengths such that the seat position may be changed to adjust the range of motion undergone during lifting. In one embodiment, such motion is in the range of from about 6 to 36 vertical inches, and the lower position is at a height in the range of from 12 to 20 inches, measured from one or more of the available seat adjustment positions on the lever element 28.

The force transfer element 42 is connected by an adjustable link 100 to the frame so that the transfer element can be moved in an up and down direction. In one embodiment, the adjustable link 100 is a hydraulic or pneumatic cylinder operated by movement of the handle 110, as shown in the phantom lines of FIGS. 4 and 5. The transfer element also is joined to the lift arms 28 by cables, which ride on the pulleys 30 so as to translate the up and down movement of the transfer element 42, respectively, to a lowering and lifting force on the lift arms 28. Those skilled in the art will recognize that the adjustable link 100 may include any one of several different movable links and may include an actuator operatively connected thereto. Other non-limiting examples of such adjustable link/actuator assemblies may include (i) a mechanical pump or screw with a handle operatively connected to the link so that a force applied to the handle moves the press element up and down, (ii) a threaded shank connecting the frame and press element together so that the press element moves when the shank is turned, or (iii) a piston/cylinder assembly, which may be operated mechanically or electrically either from a switch on the frame or remotely as desired.

In a preferred embodiment, the upright elements 21 are joined by a horizontal cross bar 38, or upper cross connector, that extends across the top of the device and is joined to the upright elements 21 at its opposite ends so as to define an angled top. The press element 45 is preferably attached to the upper cross connector 38 at one or more press element connector points. In one embodiment, the attachment is via a clevis comprising a pair of tabs 47 welded or otherwise securely connected to the upper cross connector. The tabs 47 each have a bore 49 extending there through.

A table bracket 120 is connected to the top of the cross bar 38, to which is connected a planer table, or tray 122 so that the individual can read, write, or engage in other activities whether built into the tray to enhance motor skills or provided as part of some other type of exercise. A tray or table frame 123 is connected to the cross bar by the table bracket. The tray may be adjustable in height, angle, or position by adjusting the connect tubes of the table frame. A chest plate bracket 64 carries a chest plate 60, which faces toward the frame's front and abuts against the chest of an individual during operation of the device. The chest plate 60 is preferably padded for comfort.

In one embodiment, the frame and all of its parts are formed from a sturdy rigid material such as plastic, metal, or wood. The preferred embodiment is formed from stock tube steel and welded together and thus is capable of supporting substantial weight. The pulleys may be formed from plastic, steel, or another sturdy material that is dependable and does not easily degrade over time. The device may include wheels 33 mounted for rotation underneath the legs 22 so that the device 10 can be moved to a bed or other article of furniture and the patient transferred accordingly. Likewise, the device may be used to lift someone from a chair or wheelchair or from a sitting position to a standing position in order to walk or engage in therapeutic exercises. Handles 130 may be added to the front or back of the frame for assisting the care giver or patient, respectively. The device accommodates individuals ranging from about 4 to 7 feet in height.

For the purposes of promoting an understanding of the principles of the invention, specific embodiments have been described. It should nevertheless be understood that the description is intended to be illustrative and not restrictive in character, and that no limitation of the scope of the invention is intended. Any alterations and further modifications in the described components, elements, processes, or devices, and any further applications of the principles of the invention as described herein, are contemplated as would normally occur to one skilled in the art to which the invention relates.

What is claimed is:

1. A lifting device for assisting individuals from a seated position to an upstanding position, the device comprising: a frame, and a seat connected to the frame for supporting an individual, said seat being connected to the frame by at least one lever movable between a first lower position for loading the individual into the lifting device and a second higher position, into which the lifting device is moved by applying force to a first point on the lever resulting in said individual being placed in the upstanding position.

2. The device of claim 1, including at least one shin stop member for abutting the front of a portion of a leg of said individual when the lifting device moves between the lower position and the higher position, said stop being connected to the frame and transversely movable to and fro relative to the longitudinal axis of said individual's leg portion so as to be optimally positioned irrespective of the stature of said individual to cause the leg of the individual to pivot at the knee and straighten said leg when a force is applied to a first point on the lever.

3. The device of claim 2, further comprising a pair of shin stop members, each of said stop members being movable to and fro independently of the other.

4. The device of claim 2, including a force transfer element connected to the lever, said movement of said lever being in response to a force applied to said force transfer element.

5. The device of claim 4, wherein the force transfer element is connected to said lever via a pulley assembly.

6. The device of claim 4, including an adjustable link member operably connected to the force transfer element for moving the force transfer element up and down relative to the frame.

7. The device of claim 5, including a chest plate connected to the frame for supporting the torso of the individual.

8. The device of claim 6, wherein the adjustable link member is a hydraulic or pneumatic cylinder.

9. A lifting device for assisting individuals from a seated position to an upstanding position, the device comprising:
a frame;
a lever assembly having a pair of arms connected to the frame; and
a seat for supporting an individual, said seat being releasably connected at each of its sides, respectively, to one of said arms, said lever assembly being movable between a first lower position for loading the individual into the lifting device and a second higher position, into which the lifting device is moved by applying force to the lever assembly by way of a force transfer element connected to the lever assembly by a flexible coupling resulting in said individual being placed in the upstanding position.

10. The device of claim 9, including a pair of shin stop members for stopping the front portions of legs of said individual when the lifting device moves between the lower position and the higher position, said stop members being connected to the frame and transversely movable to and fro independently of each other, and relative to the longitudinal axis of said individual's leg portions, so as to be optimally positioned irrespective of the stature of said individual to cause the legs of the individual to pivot at the knee and straighten said legs when a force is applied to the lever assembly.

11. The device of claim 10, wherein at least one pulley is operably connected to the frame between the force transfer element and the said lever assembly.

12. The device of claim 11, including an adjustable link member connecting the force transfer element and the frame for moving the force transfer element up and down relative to the frame.

13. The device of claim 12, including a chest plate connected to the frame for supporting the torso of the individual.

14. The device of claim 13, wherein the adjustable link member is a hydraulic or pneumatic cylinder.

15. A lifting device comprising a frame, said frame comprising:
a) two K frames, each of said K frames comprising:
i) a foundation element;
ii) an upright element secured to the foundation element;
iii) a brace element for bracing the device secured to both the upright and foundation elements at upright connection and foundation connection points;
iv) a lever element secured to the brace at a lever connection point such that the lever extends away from the lever connection point, the lever element movable between a first lower position and second higher position;
v) a pulley, said pulley positioned on the upright element at a pulley position, said pulley position within three inches from the upright connection point; and
vi) a flexible coupling;
b) a seating member, said seating member attaches to each lever element at a seat connection point;
c) at least one flexible linking member;
d) an upper cross connector extending horizontally between the upright elements at or above the height of the upright connection point;
e) a downwardly extensible press element attached to the upper cross connector, the press element having the capacity to extend downward from said upper cross connector;
g) a force transfer element connected to said downwardly extensible press element, such that upon extension of the press element, said force transfer element is moved downward;
wherein said flexible couplings are attached to said force transfer element and extend upwardly from said force transfer element, over the closest pulley, and laterally toward the lever element, attaching thereto, such that the angle between the upwardly extending portion and the laterally extending portion is in the range of from about 60 to 120 degrees; and wherein said angle is in the range of from about 60 to 120 degrees when the lever is in the lower position, the higher position, or therebetween.
